(19) United States
(12) Patent Application Publication
(10) Pub. No.: US 2024/0161056 A1
(43) Pub. Date: May 16, 2024

(54) Grid-Dock

(71) Applicants: Alexander Atteberry, Humble, TX (US); Ty Atteberry, Humble, TX (US)

(72) Inventors: Alexander Atteberry, Humble, TX (US); Ty Atteberry, Humble, TX (US)

(21) Appl. No.: 18/388,825

(22) Filed: Nov. 11, 2023

Related U.S. Application Data
(60) Provisional application No. 63/425,304, filed on Nov. 14, 2022.

(51) Int. Cl. G06Q 10/087; G06Q 10/02

(52) U.S. Cl. CPC G06Q 10/087; G06Q 10/02

(57) ABSTRACT

A method of measuring, identifying, and managing 3D inventory and facilitating the exchange between inventory owners and potential customers. Applicable where 3D inventory is a space to be occupied and the customer is purchasing space to store their 3D dimensional property. This invention uses software to create a 3D block of the customer's object and show available spaces for that object to be stored based on its dimensions and other criteria. This invention allows the inventory manager to arrange current occupied spaces to maximize efficiency and adjust rates based on region and volume.

### CROSS REFERENCE TO RELATED APPLICATIONS

This application claims priority to U.S. Provisional No. 63425304, filed 14 Nov. 2022, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

This invention relates to the general field of inventory management, booking space by using 3D volumes. A specific example of this is the booking of marina/dock space but could also be used to manage and book storage space for airplanes, cars, recreational vehicles, etc.

This invention allows for the management of 3D objects in an inventory and enables inventory to be viewed, reserved, and paid for in real time. When applied to marinas, this invention allows marinas to arrange and manage their dock space in a 3D grid and assign monetary rates based on volume or other units of measure. Additionally, it allows boaters to create a 3D/volumetric profile for their vessel, view available marina spaces that would accommodate their boat, reserve the location, and pay in real time.

Currently there are marina management systems and systems that allow boaters to contact marinas for dock reservations, however, there are few systems that combine both functions. This invention allows boaters to quickly view marinas that have available space and are able to accommodate their vessel. It also allows marinas to actively manage their inventory (dock space) in real time. The 3D grid system streamlines this process as it allows boaters to view only the spaces that can fit their boat's specific volume, factoring in volumes below the waterline, and volumes above the waterline. It also allows marinas to vary their rates based on the volume of the vessel which is more indicative of the vessels overall power/water/resource consumption.

US20210326776A1—Method of tracking and matching reservations, of marine docking berths at ports, for maximization of business goals

This patent describes a computerized method for tracking reservations of marine docking berths at ports receiving as an input a request for a reservation with certain criteria and outputting available options to a user. While this invention seeks to solve a similar issue, they do so in a different manner, which excludes the 3-dimensional nature of vessels and the space that they occupy. This invention analyzes user input of various criteria, including the length and width of their vessel to find and return suitable marina space, in essence also acting as an inventory management and booking system. However, the use of the 3D grid and volumetric rating is a novel inclusion to this basic principle. As mentioned above, the 3D grid accounts for all the dimensions of a vessel in determining suitable mooring space including the unique volume below the waterline and unique volume above the waterline which are critical dimensions in areas with varying tides and bridges. Additionally, the 3D nature of this management system allows for volumetric rating. Not only can rates be adjusted for various dock locations, but rates can be adjusted for volumetric dimensions as well. Taller vessels or deeper vessels that require specialized dock space can be charged based on their volume above and below the waterline. This 3D grid also allows marina owners to better manage their marina space and account for variances such as uneven seafloor, tidal changes, and bridges.

GB2489195A—Marina berth booking management system.

This invention also enables the identification and booking of marina space but on an individual basis. Private spaces that are typically occupied by vessels can be rented out by the current owner in their absence to transient boaters. This model is similar to air-bnb for marinas/dock space. While this invention also deals in the inventory management of marina space, it does so on an individual basis and does not include language about the overall dimensions volume of the vessel.

US20210350291A1—Computerized global marine distribution system (mds)

This invention tracks the location of vessels, specifically their entrance and exit from various ports with the intended application of facilitating the documentation/customs process for vessels. This invention is concerned with the data collection and presentation of vessels entering a leaving a port/marina. While it may address some areas of marina inventory management (namely the coming ang going of vessels) it is not concerned with the actual identification and reservation of marina space.

This current invention provides a solution by streamlining the boater/marina interaction and enhancing a marina's inventory management abilities. The 3D grid system allows marinas to easily map out their dock space and assign values per grid unit/region. Boaters are able to see what spaces are available and can accommodate their 3D vessel, with all dimensions accounted for and variances such as tidal changes factored into the output. Marinas are able to better visualize which spaces are occupied, which are available and make adjustments virtually in real time. Additionally, this system allows a safety margin to be added to the 3D block that represents the vessel's volume/3-dimensional space. The safety margin is a software generated buffer that adds non-rated units in every dimension to the vessel's block to accommodate tidal changes, required space between neighboring boats in a marina slip, errors in user input, etc.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1: this figure depicts a general overview of a probable scenario/application of the invention. It includes a vessel surrounded by a 3 dimensional “block” that represents its dimensions including depth below the waterline and height above. Also depicted is a dock with a block and vertical shading representing available dock space and a block with diagonal shading representing unavailable/insufficient dock space. In the background there are two shorelines connected by a bridge.

FIG. 2: this figure provides a closer view of a vessel occupying a dock space. There is a dotted line which forms a block that encloses the vessel and outlines its 3D dimensional profile. Also represented is a “safety margin” that is identified by the shaded areas surrounding the outline of the vessel block. The safety margin is the software generated buffer that surrounds the vessel to accommodate for tidal changes, and user input errors.

FIG. 3: this figure depicts a boat inside of the software generated 3-dimensional block. The dotted lines represent the outline of this block. The wavy line represents the waterline. The shaded spaces represent the safety margin/dimensions that are added to the block to accommodate for variations/user input errors.

FIG. 4: this figure depicts three different views of the grid framework overlaid on a marina/dock space. There is a 3D view that depicts the dock and the grid framework on three axes: the y axis, x axis, and z axis. There is a frontal view that represents the dock, the sea floor, the waterline, and the grid system applied vertically. There is also a top view that shows the dock, the shoreline, and the grid system applied horizontally.

FIG. 5: this figure depicts a top view of a potential scenario (which is similar to FIG. 1). There is a shoreline with a dock extending into a body of water. There are also two land masses connected by a bridge and the outline of a vessel in the bay. By the dock there are two diagonally shaded rectangles which represent available mooring space. There are four gray sections with diagonal shading which represent occupied spaces and there are four black sections that represent areas of insufficient space for the vessel to dock. While this is a top view, height and depth scales are added for reference.

### DETAILED DESCRIPTION OF THE FIGURES

This current invention provides a solution by streamlining the boater/marina interaction and enhancing a marina's inventory management abilities. The 3D grid system allows marinas to easily map out their dock space and assign values per grid unit/region. Boaters are able to see what spaces are available and can accommodate their 3D vessel, with all dimensions accounted for and variances such as tidal changes factored into the output. Marinas are able to better visualize which spaces are occupied, which are available and make adjustments virtually in real time.

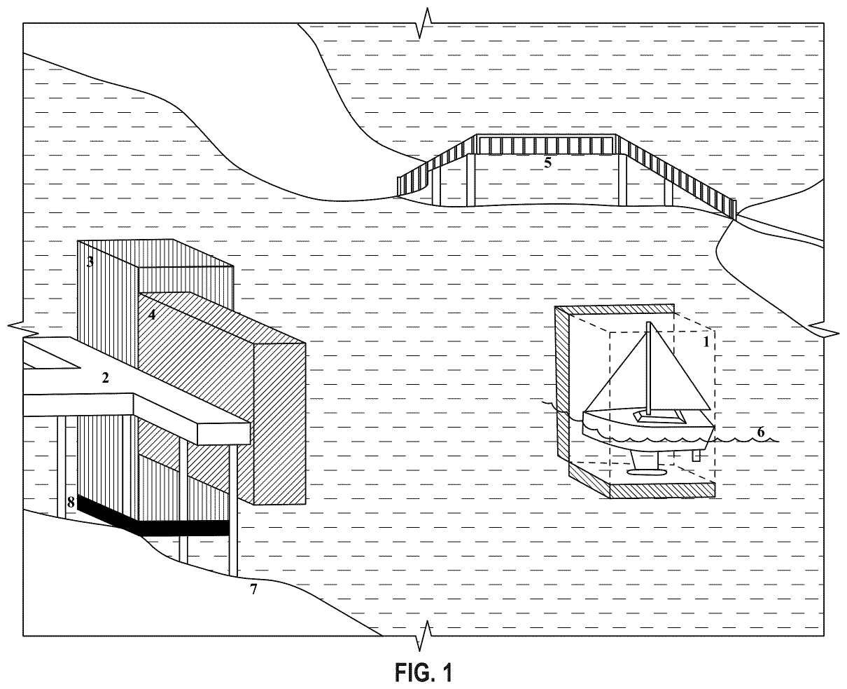

FIG. 1: this figure depicts a general overview of a probable scenario/application of the invention. It includes a vessel surrounded by a 3 dimensional “block”(1) that represents its dimensions including depth below the waterline and height above. Also depicted is a dock (2) with a block and vertical shading (3) representing available dock space and a block with diagonal shading (4) representing unavailable/insufficient dock space. In the background there are two shorelines connected by a bridge (5). The wavy line near the vessel (6) illustrates the waterline and the area of the boat below it. The diagonally shaded block by the dock (4) shows space that is unavailable/not sufficient for the vessel. The height of the available space above the waterline is restricted by the height of the bridge (5) which is 10 units; therefore, the max height of the vessels allowed at the dock is 10 units above the waterline. The depth/draft of the available space is determined by the seafloor (7) underneath the waterline by the dock. The seafloor may vary by grid/within a marina space so the depth below the waterline is a critical element in determining if a vessel will fit in a space. Also represented by the black block in the figure are the safety margins (8).

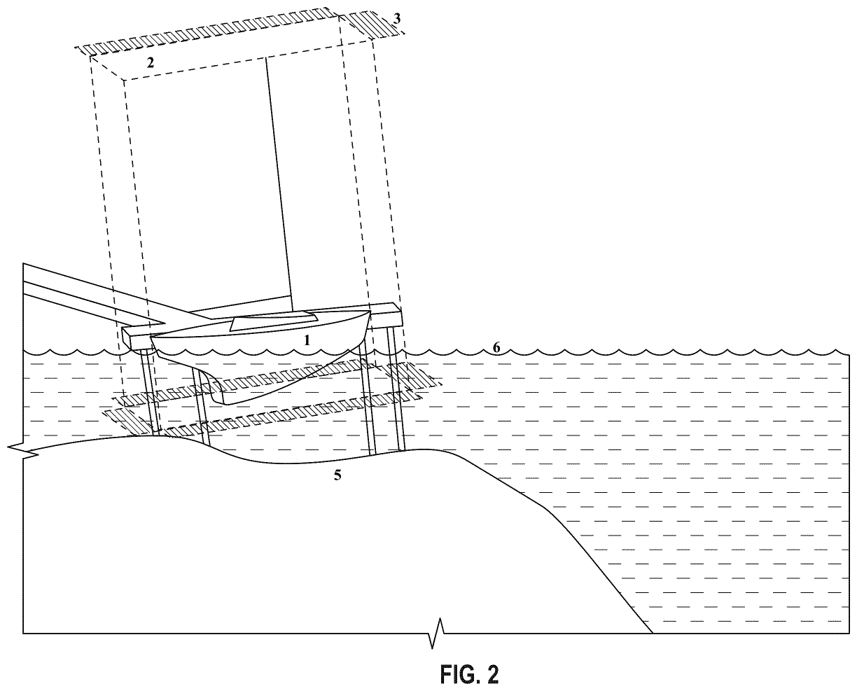

FIG. 2: this figure provides a closer view of a vessel (1) occupying a dock space. There is a dotted line which forms a block (2) that encloses the vessel and outlines its 3D dimensional profile. Also represented is a “safety margin” (3) that is identified by the shaded areas surrounding the outline of the vessel block. The safety margin is the software generated buffer that surrounds the vessel to accommodate for tidal changes, and user input errors. The maximum allowable depth of each space is set by the depth of the sea floor (5). As mentioned above, the seafloor may vary within a dock space meaning that certain slips will only be able to accommodate certain boats. The draft of a boat (its depth under the water) is therefore a critical measurement on both the vessel and the dock grid. The depth of a slip space is determined by the distance between the seafloor and the waterline (6). For a vessel, this draft is the distance from the waterline (6) to the bottom of the boat. The depth of a slip space may vary depending on tidal conditions.

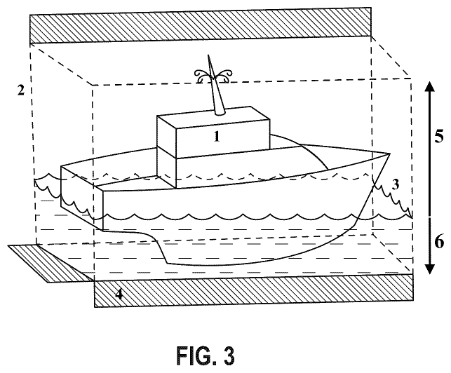

FIG. 3: this figure depicts a boat (1) inside of the software generated 3-dimensional block (2). The dotted lines represent the outline of this block. The waxy line represents the waterline (3). The shaded spaces represent the safety margin/dimensions (4) that are added to the block to accommodate for variations/user input errors. This figure more closely illustrates the distinction between the height above and below the waterline. The height above the waterline (5) is an important factor in determining clearance for bridges and other overhead hazards. The depth below the waterline (6) is important in determining clearance for subsea hazards such as reefs, shoals, or simply water depth. Both are important criteria in determining whether a vessel can access and fit into a marina.

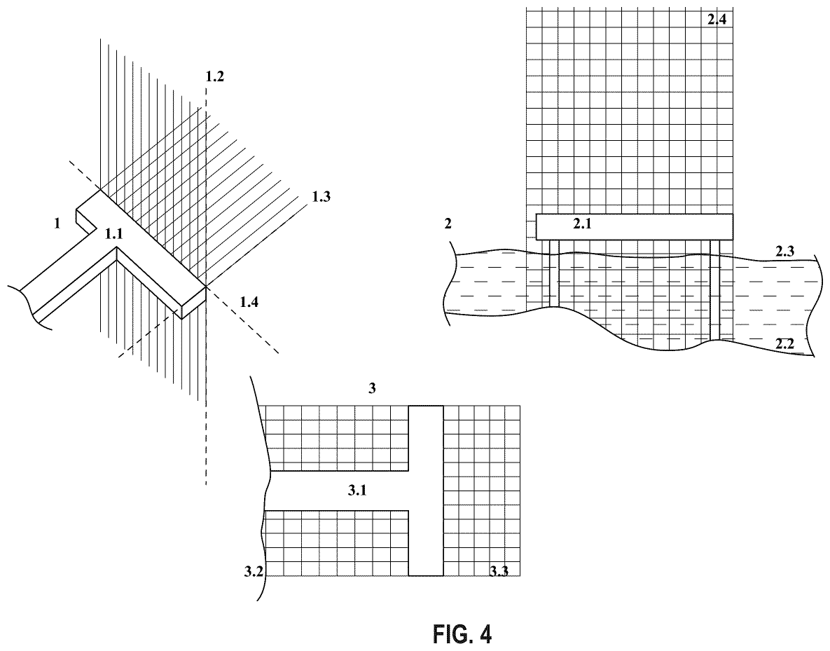

FIG. 4: this figure depicts three different views of the grid framework overlaid on a marina/dock space. There is a 3D view (1) that depicts the dock (1.1) and the grid framework on three axes: the y axis (1.2), x axis (1.3), and z axis (1.4). There is a frontal view (2) that represents the dock (2.1), the sea floor (2.2), the waterline (2.3), and the grid system applied vertically (2.4). There is also a top view (3) that shows the dock (3.1), the shoreline (3.2), and the grid system applied horizontally (3.3). This figure illustrates how 2D grids are overlapped/combined to create a 3D grid that can be used to measure and define potential dock spaces.

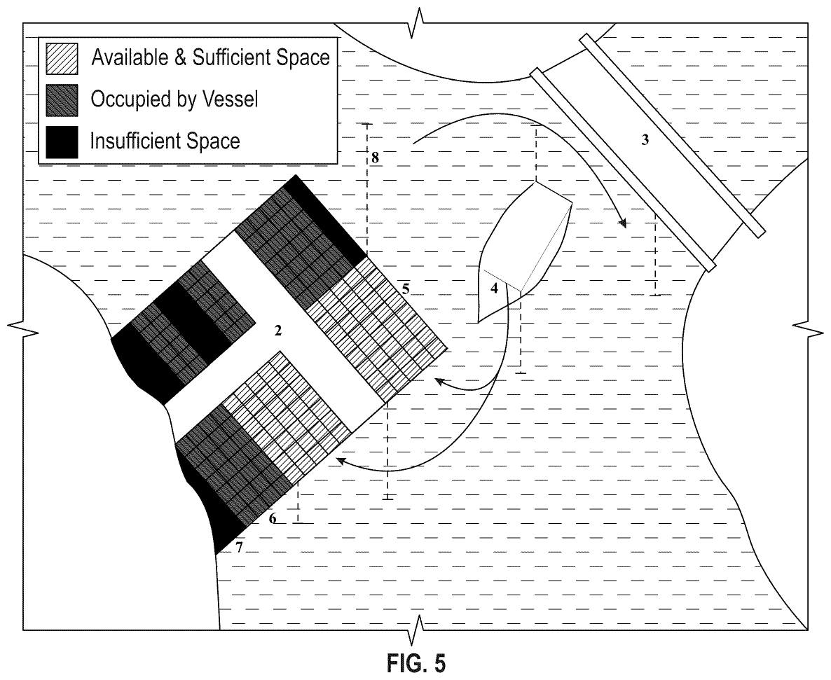

FIG. 5: this figure depicts a top view of a potential scenario (which is similar to FIG. 1). There is a shoreline (1) with a dock (2) extending into a body of water. There are also two land masses connected by a bridge (3) and the outline of a vessel (4) in the bay. By the dock there are two diagonally shaded rectangles (5) which represent available mooring space. There are four gray sections with diagonal shading (6) which represent occupied spaces and there are four black sections (7) that represent areas of insufficient space for the vessel to dock. While this is a top view, height and depth scales (8) are added for reference.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A device for managing inventory comprising:
a three-dimensional block that accurately depicts an object with an object height, an object length, and an object width,
a three-dimensional space that accurately depicts a space with a space height, a space length, and a space width,
a program that determines whether the three-dimensional block fits into the three-dimensional space, where the program provides an inventory of one or more three-dimensional spaces into which the three-dimensional block can fit.

2. The device of claim 1, where the inventory comprises one or more boat slips in a marina.

3. The device of claim 1, where the inventory comprises one or more trailer spaces in a campground.

4. The device of claim 1, where the inventory comprises one or more airplane spaces in an airport.

5. The device of claim 1, where the inventory comprises one or more boat slips in a marina, where the object height includes an above-waterline height, which is the height of a boat above a waterline, and a below-waterline height which is a draft of the boat.

6. The device of claim 5, additionally comprising a side buffer, where the side buffer is side space on either side of the boat which allows for safe passage and docking.

7. The device of claim 5, additionally comprising a length buffer, where the length buffer is a space on either end of the boat which allows for safe passage and docking.

8. The device of claim 5, additionally comprising a bottom buffer, where the bottom buffer is a distance between a marina bottom and a boat bottom which is necessary for safely parking the boat at the marina.

9. The device of claim 8, where the bottom buffer includes a bottom buffer calculation for a low tide and a high tide, such that a minimum bottom buffer exists at the low tide.

10. The device of claim 9, where the bottom buffer calculation for a low tide and a high tide is based on one or more tide tables, such that the bottom buffer calculation can be made many months in advance.

11. The device of claim 8, additionally comprising a top buffer, where the top buffer is a distance between an aerial object and a boat top which is necessary for safely moving the boat under the aerial object to the marina.

12. The device of claim 11, where the top buffer includes a top buffer calculation for a low tide and a high tide, such that a minimum top buffer exists at the high tide.

13. The device of claim 12, where the top buffer calculation for a low tide and a high tide is based on one or more tide tables, such that the top buffer calculation can be made many months in advance.

14. The device of claim 13, where the aerial object is a bridge.

15. The device of claim 1, where the inventory comprises one or more boat slips in a marina, where the object height includes an above-waterline height, which is the height of a boat above a waterline, and a below-waterline height which is a draft of the boat, additionally comprising a side buffer, where the side buffer is side space on either side of the boat which allows for safe passage and docking, additionally comprising a length buffer, where the length buffer is a space on either end of the boat which allows for safe passage and docking, additionally comprising a bottom buffer, where the bottom buffer is a distance between a marina bottom and a boat bottom which is necessary for safely parking the boat at the marina, where the bottom buffer includes a bottom buffer calculation for a low tide and a high tide, such that a minimum bottom buffer exists at the low tide, where the bottom buffer calculation for a low tide and a high tide is based on one or more tide tables, such that the bottom buffer calculation can be made many months in advance, additionally comprising a top buffer, where the top buffer is a distance between an aerial object and a boat top which is necessary for safely moving the boat under the aerial object to the marina, where the top buffer includes a top buffer calculation for a low tide and a high tide, such that a minimum top buffer exists at the high tide, where the top buffer calculation for a low tide and a high tide is based on one or more tide tables, such that the top buffer calculation can be made many months in advance,
where, there are three, two-dimensional views created—a front view, a top view, and a side view—where the front view, the top view and the side view are combined into a three-dimensional grid.

16. The grid of claim 15, where a user can enter a boat height, a boat length and a boat width into a database, along with a desired reservation date range, and a software program will supply the user with a marina grid that identifies one or more slips that could accommodate the user's boat during the desired reservation date range.

17. The device of claim 15, where a user can enter a boat height, a boat length and a boat width into a database, along with a desired reservation date range and a desired geographical range, and a software program will supply the user with a marina grid that identifies one or more slips in one or more marinas that could accommodate the user's boat during the desired reservation date range within the desired geographical range.

18. The device of claim 15, additionally comprising a weather factor, where the weather factor can add one or more additional feet to the side buffer, the length buffer, and the height buffer in cases of extreme weather.

19. The device of claim 15, additionally comprising a three-dimensional grid of a rental space, where the user of the invention manages the rental space, where the user of the invention inputs one or more rental data to create a current inventory of one or more rental spaces from which a person wish to rent one of the rental spaces can see a customized three-dimensional view of the rental space to see where he/she could park his/her item, where the customize three-dimensional view of the rental space is simultaneously fed into an accounting program that estimates a current profit/loss of a business which is managed by the user based upon an inventory.

20. The device of claim 19, where the rental space is a marina.

21. The device of claim 19, where the rental space is an airport.

22. The device of claim 19, where the rental space is an RV park.

23. The device of claim 19, where the rental space is a parking lot for vehicles.

24. The device of claim 15, where each of one or more rental spaces has a volumetric rating and an associated volumetric pricing based on volume of the item as opposed to a length pricing based just on the length of the item.

25. The device of claim 15, additional comprising a volumetric rating which includes a volumetric calculation and a placement calculation, where the volumetric calculation is based upon the height, length and width of the item, and where the placement calculation is based upon one or more desirability features.

26. The device of claim 25, where the one or more desirability features are selected from the group consisting of location, proximity to gates, proximity to bathrooms, ease of parking, scenery, and access to resources such as fuel, electricity, groceries/provisions, water availability, depth of water.

27. The device of claim 26, where the volumetric rating allows a user to assign a different price to each of the one or more available spaces.

28. The device of claim 27, where the different price can be divided into at least two variables, where each variable has a different variable cost.

29. The device of claim 28, where one variable cost could be for a base volume and a second variable cost could be for an excess volume.
